(19) United States
(12) Patent Application Publication
(10) Pub. No.: US 2016/0229942 A1
(43) Pub. Date: Aug. 11, 2016

(54) ACRYLIC-MODIFIED, PB-CURABLE COMPOSITION HAVING EXCELLENT LIGHT RESISTANCE AND EXCEPTIONAL MECHANICAL STRENGTH

(71) Applicant: NIPPON SODA CO., LTD., Chiyoda-ku, Tokyo (JP)

(72) Inventor: Hiroki HASHIMOTO, Ichihara-shi (JP)

(21) Appl. No.: 15/022,475

(22) PCT Filed: Sep. 18, 2014
(86) PCT No.: PCT/JP2014/004807

§ 371 Date: Mar. 16, 2016

(30) Foreign Application Priority Data
Oct. 4, 2013 (JP) 2013-208826
Oct. 4, 2013 (JP) 2013-208832
Oct. 4, 2013 (JP) 2013-208833

(51) Int. Cl. C08F 290/04

(52) U.S. Cl. CPC C08F 290/048

(57) ABSTRACT

A photocurable composition according to the present invention comprising
(A) a terminal-modified (hydrogenated) polybutadiene represented by formula [I]:

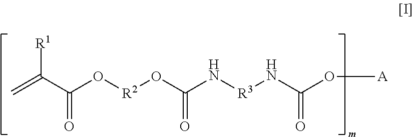

(wherein R¹ represents a hydrogen atom or a methyl group, R² and R³ each independently represent a C1-C10 linear or branched alkylene group, a C3-C8 cycloalkylene group optionally substituted by a C1-C6 alkyl group, or a combination of the groups thereof, A represents a polymer chain obtained by polymerizing butadiene, or a polymer chain obtained by hydrogenating the former polymer chain thereof, and m represents 1 or 2)
(B) a (meth)acrylic acid ester monomer, and
(C) a photo-radical polymerization initiator.

### TECHNICAL FIELD

The present invention relates to a photocurable composition containing a terminal-modified (hydrogenated) polybutadiene, a (meth)acrylic acid ester monomer, and a photo-radical polymerization initiator, and a cured product obtained by photocuring the photocurable composition.

This application claims priority to Japanese Patent Application No. 2013-208826, filed on Oct. 4, 2013, Japanese Patent Application No. 2013-208832, filed on Oct. 4, 2013, and Japanese Patent Application No. 2013-208833, filed on Oct. 4, 2013, which are incorporated herein by reference.

### BACKGROUND ART

Photocurable compositions containing a polybutadiene or a hydrogenated polybutadiene with its terminal portion modified by an acryloyl group or a methacryloyl group, a (meth)acrylic acid ester monomer, and a photo-radical polymerization initiator are known. These compositions can be photocured to give cured products that can be applied to a variety of applications.

Patent document 1 discloses a photocurable composition containing (C) 0.1 to 10 parts by mass of a photo-radical polymerization initiator, with respect to a total of 100 parts by mass of (A) 20 to 90% by mass of a reactive polymer having a terminal (meth)acryloyl group and (B) 80 to 10% by mass of a (meth)acrylic acid ester monomer, and a cured product thereof.

Patent document 2 discloses a composition containing an acrylate group terminated oligomer, an acrylate or methacrylate group terminated reactive diluent from having 3 to 20 carbon atoms, and a photo initiator selected from the group consisting of 2-hydroxycyclohexylphenone, diethoxyacetophenone, 1-(4-dodecylphenyl)-2-hydroxy-2-methylpropan-1-one, 2-hydroxy-2-methyl-1-phenyl-propan-1-one, and mixtures thereof.

### PRIOR ART DOCUMENTS

### Patent Documents

Patent document 1: Japanese Unexamined Patent Application Publication No. 2007-39587

Patent document 2: Japanese Unexamined Patent Application Publication No. S60-195538

### SUMMARY OF THE INVENTION

### Object to be Solved by the Invention

A photocurable composition from which a cured product does not cause yellowing when photocured and has good mechanical properties can be obtained was awaited. Further, a cured product that hardly turns yellow when irradiating light was awaited.

### Means to Solve the Object

The present inventors have made intensive studies and have consequently found a photocurable composition containing 0.1 to 20 parts by weight of a photo-radical polymerization initiator, with respect to 100 parts by weight in total of 5 to 40% by weight of a terminal-modified (hydrogenated) polybutadiene having a specific structure and 95 to 60% by weight of a (meth)acrylic acid ester monomer. The present inventors have found that this photocurable composition can be photocured without yellowing and the obtained cured product has good mechanical properties. As a result, the present invention has been completed.

The present inventors have also found a photocurable composition containing a terminal-modified (hydrogenated) polybutadiene having a specific structure, a (meth)acrylic acid ester monomer, and a photo-radical polymerization initiator having a specific structure. This photocurable composition can be photocured without yellowing and the resulting cured product shows good mechanical properties.

Furthermore, the present inventors have found a photocurable composition containing a terminal-modified (hydrogenate) polybutadiene having a specific structure, tricyclodecanedimethanol di(meth)acrylate; and a photo-radical polymerization initiator. This photocurable composition can be photocured without yellowing and the obtained cured product has good mechanical properties.

Specifically, the present invention relates to photocurable compositions and photocured products of the following (1) to (10).

(1) A photocurable composition containing

(C) 0.1 to 20 parts by weight of a photo-radical polymerization initiator, with respect to 100 parts by weight in total of

(A) 5 to 40% by weight of a terminal-modified (hydrogenated) polybutadiene represented by formula [I]:

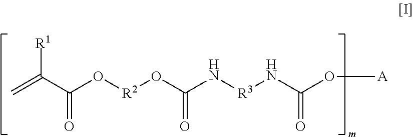

(wherein R¹ represents a hydrogen atom or a methyl group, R² and R³ each independently represent a C1-C10 linear or branched alkylene group, a C3-C8 cycloalkylene group optionally substituted by a C1-C6 alkyl group, or a combination of the groups thereof, A represents a polymer chain obtained by polymerizing butadiene, or a polymer chain obtained by hydrogenating the polymer chain thereof, and m represents 1 or 2), and

(B) 95 to 60% by weight of a (meth)acrylic acid ester monomer.

(2) The photocurable composition according to (1), wherein the terminal-modified (hydrogenated) polybutadiene represented by formula [I] is obtained by reacting an isocyanate represented by formula [II]:

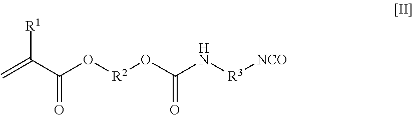

(wherein R¹ represents a hydrogen atom or a methyl group, R² and R³ each independently represent a C1-C10 linear or branched alkylene group, a C3-C8 cycloalkylene group optionally substituted by a C1-C6 alkyl group, or a combination of the groups thereof), with a hydroxyl group-terminated polybutadiene or hydrogenated polybutadiene represented by formula [III]:

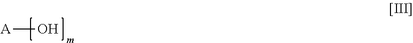

(wherein A represents a polymer chain obtained by polymerizing butadiene, or a polymer chain obtained by hydrogenating the polymer chain thereof, and m represents 1 or 2).

(3) A photocurable composition comprising:

(A) a terminal-modified (hydrogenated) polybutadiene represented by formula [I]:

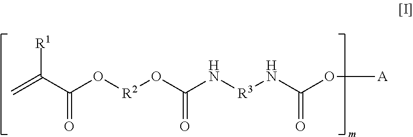

(wherein R¹, R², R³, A, and m and have the same meaning as above),

(B) a (meth)acrylic acid ester monomer, and

(C) a photo-radical polymerization initiator represented by formula [IV]:

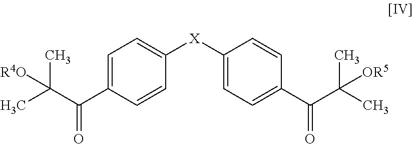

(wherein X represents any one selected from the group consisting of O, CH₂, CH(CH₃), and C(CH₃)₂, and R⁴ and R⁵ each independently represent a hydrogen atom, a methyl group, or a trimethylsilyl group).

(4) The photocurable composition according to (3), wherein the photo-radical polymerization initiator represented by formula [IV] is 2-hydroxy-1-(4-(4-(2-hydroxy-2-methyl-propionyl)-benzyl)-phenyl)-2-methyl-propan-1-one.

(5) The photocurable composition according to (3) or (4), comprising:

(C) 3 to 7 parts by weight of the photo-radical polymerization initiator, with respect to 100 parts by weight in total of

(A) the terminal-modified (hydrogenated) polybutadiene represented by formula [I], and

(B) the (meth)acrylic acid ester monomer.

(6) The photocurable composition according to any one of (3) to (5), wherein the terminal-modified (hydrogenated) polybutadiene represented by formula [I] is obtained by reacting an isocyanate compound represented by formula [II]:

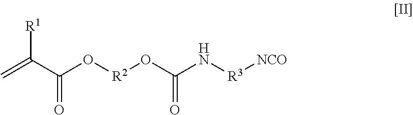

(wherein R¹, R², and R³ have the same meaning as above), with a hydroxyl group-terminated polybutadiene or hydrogenated polybutadiene represented by formula [III]:

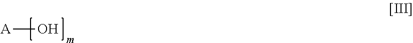

(wherein A and m have the same meaning as above).

(7) A photocurable composition comprising:

(A) a terminal-modified (hydrogenated) polybutadiene represented by formula [I]:

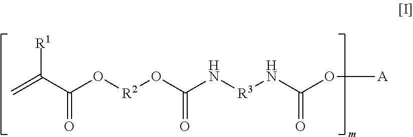

(wherein R¹, R², R³, A, and m have the same meaning as above),

(B) tricyclodecanedimethanol di(meth)acrylate,and

(C) a photo-radical polymerization initiator.

(8) The photocurable composition according to (7), wherein the terminal-modified (hydrogenated) polybutadiene represented by formula [I] is obtained by reacting an isocyanate compound represented by formula [II]:

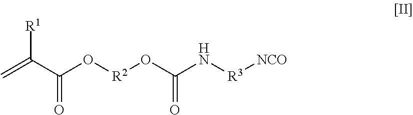

(wherein R¹, R², and R³ have the same meaning as above), with a hydroxyl group-terminated polybutadiene or hydrogenated polybutadiene represented by formula [III]:

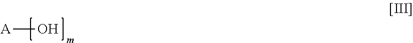

(wherein A and m have the same meaning as above).

(9) The photocurable composition according to any one of (1) to (8), wherein the terminal-modified (hydrogenated) polybutadiene represented by formula [I] has a number average molecular weight (Mn) of 1,000 to 100,000.

(10) A cured product obtained by photocuring the photocurable composition according to any one of (1) to (9).

### EFFECT OF THE INVENTION

A colorless and transparent cured product can be obtained by photocuring the photocurable composition of the present invention. The obtained cured product hardly turns yellow when irradiating light and has high heat resistance. A cured product showing good mechanical properties will be a material suitable for optical materials and the like.

### MODE OF CARRYING OUT THE INVENTION

In the present invention, the definitions of substituents are as follows.

“A C1-C10 linear or branched alkylene group” of R² and R³ includes a methylene group, an ethylene group, a propylene group, a methylethylene group, a butylene group, a 1,2-dimethylethylene group, a pentylene group, a 1-methylbutylene group, a 2-methylbutylene group, a hexylene group, and the like.

Examples of “a C1-C6 alkyl group” in “a C3-C8 cycloalkylene group optionally substituted by a C1-C6 alkyl group” of R² and R³ include a methyl group, an ethyl group, an n-propyl group, an isopropyl group, an n-butyl group, a 1-methyl-n-propyl group, a 2-methyl-n-propyl group, a t-butyl group, an n-pentyl group, a 1-methyl-n-butyl group, a 2-methyl-n-butyl group, a 3-methyl-n-butyl group, a 1,1-dimethyl-n-propyl group, a 2,2-dimethyl-n-propyl group, a 1,2-dimethyl-n-propyl group, a 1-ethyl-n-propyl group, an n-hexyl group, a 1-methyl-n-pentyl group, a 2-methyl-n-pentyl group, a 3-methyl-n-pentyl group, a 4-methyl-n-pentyl group, a 1,1-dimethyl-n-butyl group, a 2,2-dimethyl-n-butyl group, a 3,3-dimethyl-n-butyl group, a 1,2-dimethyl-n-butyl group, a 1,3-dimethyl-n-butyl group, a 2,3-dimethyl-n-butyl group, a 1-ethyl-n-butyl group, a 2-ethyl-n-butyl group, and a 1-isopropyl-n-propyl group.

As the “C3-C8 cycloalkylene group optionally substituted by a C1-C6 alkyl group” of R² and R³, cyclopropylene, 2-methylcyclopropylene, cyclobutylene, 2,2-dimethylcyclobutylene, cyclopentylene, 2,3-dimethylcyclopentylene, cyclohexylene, 1,3,3-trimethylcyclohexylene, cyclooctylene or the like may be examplified.

A “combination of the groups thereof” of R² and R³ means “a group made by the combination of a C1-C10 linear or branched alkylene group and a C3-C8 cycloalkylene group optionally substituted by a C1-C6 alkyl group”.

As the “group made by the combination of a C1-C10 linear or branched alkylene group and a C3-C8 cycloalkylene group optionally substituted by a C1-C6 alkyl group”, a methylene-cyclopropylene group, a methylene-cyclopentylene group, a methylene-2,3-dimethylcyclopentylene group, a methylene-1,3,3-trimethylcyclohexylene group, an ethylene-cyclopropylene group, an ethylene-cyclohexylene group, an ethylene-3,3-dimethylcyclohexylene group, a methylene-cyclopropylene-methylene group, an ethylene-cyclohexylene-methylene group, a hexylene-cyclohexylene-methylene group, or the like may be examplified. Further, the order of these sequences can be replaced in the groups.

(Photocurable Composition)

A photocurable composition of the present invention contains 0.1 to 20 parts by weight of a photo-radical polymerization initiator as component (C), with respect to 100 parts by weight in total of 5 to 40% by weight of a terminal-modified (hydrogenated) polybutadiene represented by formula [I] as component (A) and 95 to 60% by weight of a (meth)acrylic acid ester monomer as component (B).

The photocurable composition of the present invention can contain the terminal-modified (hydrogenated) polybutadiene represented by formula [I] as component (A), a (meth)acrylic acid ester monomer as component (B), and a photo-radical polymerization initiator represented by formula [IV] as component (C).

In this case, the added amount of each component is not particularly limited, but is preferably 0.1 to 20 parts by weight, and more preferably 3 to 7 parts by weight of component (C), with respect to 100 parts by weight in total of 20 to 90% by weight of component (A) and 80 to 10% by weight of component (B).

The photocurable composition of the present invention can contain the terminal-modified (hydrogenated) polybutadiene represented by formula [I] as component (A), tricyclodecanedimethanol di(meth)acrylate as component (B), and a photo-radical polymerization initiator as component (C). In this case, the added amount of each component is not particularly limited, but preferably 0.1 to 20 parts by weight of the component (C), with respect to 100 parts by weight in total of 20 to 90% by weight of component (A) and 80 to 10% by weight of component (B).

The photocurable composition of the present invention can further contain other components, in addition to component (A), component (B), and component (C).

(Component (A))

The component (A) contained in the photocurable composition of the present invention refers to a terminal-modified (hydrogenated) polybutadienes represented by following formula [I].

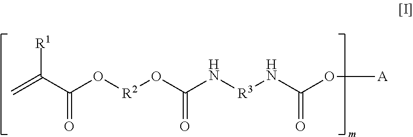

In formula [I], R¹ represents a hydrogen atom or a methyl group, R² and R³ each independently represent a C1-C10 linear or branched alkylene group, a C3-C8 cycloalkylene group optionally substituted by a C1-C6 alkyl group, or a combination of the groups thereof, A represents a polymer chain obtained by polymerizing butadiene, or a polymer chain obtained by hydrogenating the polymer chain thereof, and m represents 1 or 2.

R² is preferably a linear C2-C10 alkylene group, more preferably a linear C2-C6 alkylene group, and still more preferably an ethylene or propylene group.

R³ is preferably a linear C2-C6 alkylene group, or a group made by the combination of a linear or branched C1-C10 alkylene group and a C3-C8 cycloalkylene group optionally substituted by a C1-C6 alkyl group. Further, more preferably, a group made by the combination of a C1-C10 linear or branched alkylene group and C3-C8 cycloalkylene group optionally substituted by a C1-C6 alkyl group are bonded is a group represented by following formula (1) or (2). In formulae (1) and (2), *S represent binding positions.

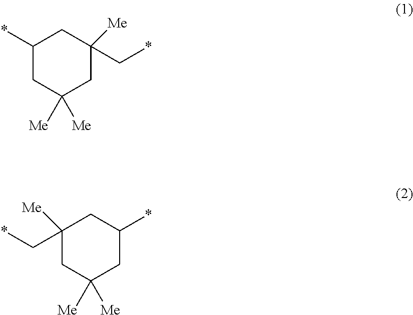 [SMILES: *CC1(C)CC(*)CC(C)(C)C1 ; *CC1(C)CC(*)CC(C)(C)C1]

In formula [I], a polymer chain obtained by polymerizing butadiene, or a polymer chain obtained by hydrogenating the polymer chain thereof, represented by A, has as a skeleton,

a repeating unit of a 1,4-bond represented by formula [V]:

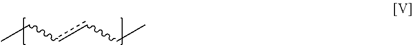

(wherein the double line portion described by solid and dotted lines represents a single bond or a double bond, and wavy lines represent either a cis- or trans-isomer in the case of a double bond), and a repeating unit of a 1,2-bond represented by formula [VI]:

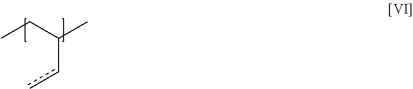

(wherein the double line portion described by solid and dotted lines represents a single bond or a double bond).

When the double line portion described by solid and dotted lines represents a double bond, it is an unhydrogenated polybutadiene, and when the portion represents a single bond, it is a hydrogenated polybutadiene. In case of a hydrogenated polybutadiene, 100% hydrogenation of the double bonds is not required, and the residual ratio of the double bonds is not particularly limited.

Moreover, when the repeating unit of a 1,4-bond represented by formula [V] has a double bond, a trans-isomer, a cis-isomer, or a mixtures thereof can be present.

The ratio of the repeating unit of a 1,4-bond represented by formula [V], and the ratio of the 1,2-bond represented by formula [VI] are from 0 to 100 mol %, respectively. That is, in the present invention, a polymer chain represented by A may be comprised by only the repeating unit of 1,4-bonds or 1,2-bonds, or by a mixture of the repeating unit of 1,4-bonds and 1,2-bonds. In particular, preferably, the ratio of the repeating unit of 1,2-bonds is 75 to 100 mol %, and the ratio of the repeating unit of 1,4-bonds is 25 to 0 mol %.

A number average molecular weight of the terminal-modified (hydrogenated) polybutadiene represented by formula [I] measured by GPC (gel filtration) method using polystyrene as a standard is preferably 1,000 to 100,000, and more preferably 1,000 to 10,000.

A method of prepareing the terminal-modified (hydrogenated) polybutadiene represented by formula [I] is not particularly limited, and it can be prepared by the method described in Japanese Unexamined Patent Application Publication No. 2011-116965.

Preferably, the terminal-modified (hydrogenated) polybutadiene represented by formula [I] is obtained by reacting an isocyanate represented by formula [II]:

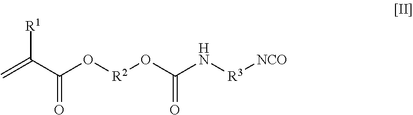

(wherein R¹, R², and R³ have the same meaning as above), with a hydroxyl group-terminated polybutadiene or hydrogenated polybutadiene represented by formula [III]:

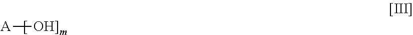

(wherein A and m have the same meaning as above). Known methods described in Japanese Unexamined Patent Application Publication No. 2011-116965 and the like can be used as a method for preparing the compound represented by formula [II] and a method of reacting the compound represented by formula [II] with the compound represented by formula [III].

Specifically, as the compound represented by formula [III], NISSO-PB-G-1000, NISSO-PB-G-2000, NISSO-PB-G-3000, and the hydrogenated compounds thereof such as NISSO-PB-GI-1000, NISSO-PB-GI-2000, NISSO-PB-GI-3000 (all compounds are manufactured by Nippon Soda Co., Ltd.), Poly bd R45HT (manufactured by Idemitsu Kosan Co., Ltd.). These compounds may be used alone or used by combination of two or more thereof.

The terminal-modified (hydrogenated) polybutadiene represented by formula [I] is preferably a compound represented by Table 1, and more preferably a compound represented by Table 2. In Table 1, R¹, R², A, and m have the same meaning as above, and in Table 2, R¹, A, and m have the same meaning as above.

TABLE 1

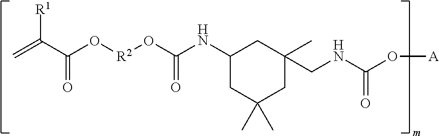

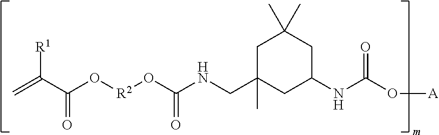

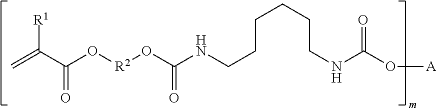

TABLE 2

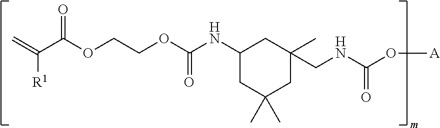

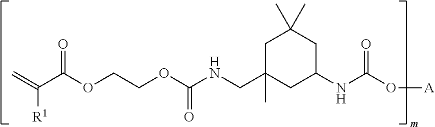

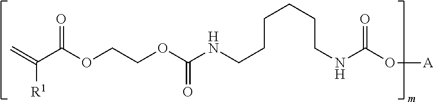

(Component (B))

The component (B) contained in the photocurable composition of the present invention is a (meth)acrylic acid ester monomer. As the (meth)acrylic acid ester monomer, monofunctional (meth)acrylate monomers such as methyl (meth)acrylate, ethyl (meth)acrylate, propyl (meth)acrylate, isopropyl (meth)acrylate, butyl (meth)acrylate, isobutyl (meth)acrylate, benzyl (meth)acrylate, phenoxyethyl (meth)acrylate, tetrahydrofurfuryl (meth)acrylate, lauryl (meth)acrylate, dicyclopentenyl (meth)acrylate, dicyclopentanyl (meth)acrylate, dicyclopentenyloxyethyl (meth)acrylate, isobornyl (meth)acrylate, 2,3-dibromopropyl (meth)acrylate, 2-hydroxyethyl (meth)acrylate, 2-hydroxypropyl (meth)acrylate, 3-hydroxypropyl (meth)acrylate, 3-dihydroxypropyl (meth)acrylate, 2,3-dihydroxypropyl (meth)acrylate, 2-hydroxyethyl (meth)acrylate, 3-methacryloyloxypropyltrimethoxysilane, 11-methacryloyloxyundecyltrimethoxysilane, (meth)acrylamide, or the like.

bifunctional (meth)acrylate monomers such as ethylene glycol di(meth)acrylate, triethylene glycol di(meth)acrylate, propylene glycol di(meth)acrylate, polyethylene glycol di(meth)acrylate, polypropylene glycol di(meth)acrylate, neopentyl glycol di(meth)acrylate, 1,4-butanediol di(meth)acrylate, 1,6-hexanediol di(meth)acrylate, 1,9-nonanediol diacrylate, 1,10-decanediol di(meth)acrylate, tricyclodecanedimethanol di(meth)acrylate, dipentaerythritol di(meth)acrylate, bisphenol A diglycidyl (meth)acrylate, 2,2-bis[4-(meth)acryloyloxyethoxyphenyl]propane, 2,2-bis[4-(meth)acryloyloxypolyethoxyphenyl]propane, 2,2-bis[4-[3-(meth)acryloyloxy-2-hydroxypropoxy]phenyl]propane, 1,2-bis[3-(meth)acryloyloxy-2-hydroxypropoxy]ethane, pentaerythritol di(meth)acrylate, 1,2-bis-(3-methacryloyloxy-2-hydroxypropoxy)ethane, [2,2,4-trimethylhexamethylenebis(2-carbamoyloxyethyl)]dimethacrylate, and 1,3-di(meth)acryloyloxy-2-hydroxypropane, or the like,

trifunctional or higher functional (meth)acrylate monomers such as trimethylolpropane tri(meth)acrylate, trimethylolethane tri(meth)acrylate, tetramethylolmethane tri(meth)acrylate, pentaerythritol tetra(meth)acrylate, N,N′-(2,2,4-trimethylhexamethylene)bis[2-(aminocarboxy)propane-1,3-diol]tetramethacrylate, and 1,7-diacryloyloxy-2,2,6,6-tetraacryloyloxymethyl-4-oxyheptane, or the like may be exemplified.

In the present invention, among the monomers above, monofunctional (meth)acrylate monomers or bifunctional (meth)acrylate monomers are preferable, and isobornyl (meth)acrylate is more preferably. 1,6-Hexanediol di(meth)acrylate and tricyclodecanedimethanol di(meth)acrylate are still more preferable. These monomers can be used alone or used by combination of two or more thereof.

As the (meth)acrylic acid ester monomer in the component (B) contained in the photocurable composition of the present invention, tricyclodecanedimethanol di(meth)acrylate which is a bifunctional (meth)acrylate represented by formula [VII] is particularly preferable.

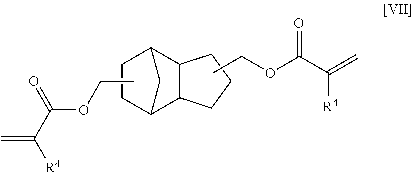

In formula [VII], R⁴ each independently represents a hydrogen atom or a methyl group. Tricyclodecanedimethanol di(meth)acrylate is commercially available.

(Component (C))

The component (C) contained in the photocurable composition of the present invention is a photo-radical polymerization initiator. As the photo-radical polymerization initiator, alkylphenone-based photopolymerization initiators, benzophenone-based photopolymerization initiators, acylphosphine oxide-based photopolymerization initiators, titanocene-based photopolymerization initiators, or other photpolymerization initiators may be exemplified.

As the alkylphenone-based photopolymerization initiators, benzyl dimethyl ketal compounds such as 2,2-dimethoxy-1,2-diphenylethan-1-one (IRUGACURE (registered trademark) 651), α-hydroxyalkyl phenones such as 1-hydroxy-cyclohexyl-phenyl ketone (IRUGACURE (registered trademark) 184), 2-hydroxy-2-methyl-1-phenyl-propan-1-one (Darocur (registered trademark) 1173), 1-(4-(2-hydroxyethoxy)-phenyl)-2-hydroxy-2-methylpropane (SB-PI 759), 1-(4-(2-hydroxyethoxy)-phenyl-2-hydroxy-2-methyl-1-propan-1-one (IRUGACURE (registered trademark) 2959), 2-hydroxy-1-(4-(4-(2-hydroxy-2-methyl-propionyl)-benzyl)-phenyl)-2-methyl-propan-1-one (IRUGACURE (registered trademark) 127), and phenylglyoxylic acid methyl ester (Darocur (registered trademark) MBF), and α-amino alkyl phenones such as 2-methyl-1-(4-methylthiophenyl)-2-morpholinopropan-1-one (IRUGACURE (registered trademark) 907), 2-benzyl-2-dimethylamino-1-(4-morpholinophenyl)-butanone-1 (IRUGACURE (registered trademark) 369), 2-(dimethylamino)-2-((4-methylphenyl)methyl)-1-(4-(4-morpholinyl)phenyl)-1-butanone (IRUGACURE (registered trademark) 379EG) or the like may be exemplified.

As the benzophenone-based photpolymerization initiators, benzophenone (SB-PI 710), methyl-o-benzoyl benzoate (SB-PI 711), 4-methylbenzophenone (SB-PI 712), 4,4′-bis(dimethylamino)benzophenone (SB-PI 701), (4-(methylphenylthio)phenyl)-phenylmethane (SB-PI 705) or the like may be exemplified.

As the acylphosphine oxide-based photopolymerization initiators, 2,4,6-trimethylbenzoyl-diphenyl-phosphine oxide (LUCIRIN (registered trademark) TPO), bis(2,4,6-trimethylbenzoyl)-phenylphosphine oxide (IRUGACURE (registered trademark) 819), a water dispersion of bis(2,4,6-trimethylbenzoyl)-phenylphosphine oxide (IRUGACURE (registered trademark) 819DW) or the like may be exemplified.

As the titanocene-based photopolymerization initiators, bis(η5-2,4-cyclopentadien-1-yl)-bis(2,6-difluoro-3-(1H-pyrrol-1-yl)-phenyl)titanium (IRUGACURE (registered trademark) 784) or the like may be exemplified.

As other photopolymerization initiators, oxime esters such as 1,2-octanedione, 1-(4-phenylthio)-,2-(O-benzoyloxime)) (IRUGACURE (registered trademark) OXE01), ethanone, 1-(9-ethyl-6-(2-methylbenzoyl)-9H-carbazol-3-yl)-,1-(O-acetyloxime) (IRUGACURE (registered trademark) OXE02) or the like may be exemplified.

These initiators may be used alone or use by combination of two or more thereof.

The component (C) contained in the photocurable composition of the present invention is preferably the photo-radical polymerization initiator represented by formula [IV]:

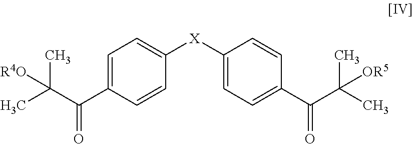

(wherein X represents any one selected from the group consisting of O, CH₂, CH(CH₃), and C(CH₃)₂, and R⁴ and R⁵ each independently represent a hydrogen atom, a methyl group, or a trimethylsilyl group).

The photo-radical polymerization initiator represented by formula [IV] is preferably 2-hydroxy-1-(4-(4-(2-hydroxy-2-methyl-propionyl)-benzyl)-phenyl)-2-methyl-propan-1-one. 2-Hydroxy-1-(4-(4-(2-hydroxy-2-methyl-propionyl)-benzyl)-phenyl)-2-methyl-propan-1-one (manufactured by Ciba Specialty Chemicals Co., Ltd., trade name: IRUGACURE (registered trademark) 127) is commercially available

(Other Components)

Other components may be added or mixed to the photocurable composition of the present invention, as long as its properties is not deteriorated, according to a purpose. Specifically, as the other components, a polymerization inhibitor may be exemplified. For instance, as the polymerization inhibitor, though it is not particularly limited, phenols such as 2,6-di-t-butyl-4-hydroxytoluene (BHT), 2,6-di-t-butyl-4-methylphenol, 2,2′-methylenebis(4-methyl-6-t-butylphenol), 4,4′-butylidenebis(3-methyl-6-t-butylphenol), 4,4′-thiobis(3-methyl-6-t-butylphenol), 3,9-bis[2-(3-(3-t-butyl-4-hydroxy-5-methylphenyl)-propionyloxy)-1,1-dimethylethyl]2,4,8,10-tetraoxaspiro(5,5)undecane, triethylene glycol-bis-3-(3-t-butyl-4-hydroxy-5-methylpenylpropionate, n-octadecyl-3-(3,5-di-t-butyl-4-hydroxyphenyl)propionate, i-octyl-3-(3,5-di-t-butyl-4-hydroxyphenyl)propionate, hexamethylene bis(3-(3,5-di-t-butyl-4-hydroxyphenyl)propionate, 4,6-bis(octylthiomethyl)-o-cresol, 4,6-bis(dodecylthiomethyl)-o-cresol, pentaerytolyl tetrakis[3-(3,5-di-t-butyl-4-hydroxyphenyl)propionate], tris(3,5-di-t-butylhydroxybenzyl)isocyanurate, tris(4-t-butyl-2,6-dimethyl-5-hydroxybenzyl)isocyanurate, 2,6-di-t-butyl-4-(4,6-bis(octylthio)-1,3,5-triazin-2-ylamino)phenol, thiodiethylene bis[3-(3,5-di-t-butyl-4-hydroxyphenyl)propionate, N,N′-hexane-1,6-diylbis[3-(3,5-di-t-butyl-4-hydroxyphenylpropionamide, 3,3′,3″,5,5′,5″-hexa-t-butyl-a,a′,a″-(mesitylene-2,4,6-triyl)tri-p-cresol, or the like, calcium diethylene bis[[[3,5-bis(1,1-dimethylethyl)-4-hydroxyphenyl]methyl]phosphonate]; quinones such as p-benzoquinone, anthraquinone, naphthoquinone, phenanthraquinone, p-toluquinone, 2,6-dichloroquinone, 2,5-diphenyl-p-benzoquinone, 2,5-diacetoxy-p-benzoquinone, 2,5-dicaproxy-p-benzoquinone, and 2,5-diacyloxy-p-benzoquinone; hydroquinones such as hydroquinone, p-t-butylcatechol, 2,5-di-t-butylhydroquinone, mono-t-butylhydroquinone, monomethylhydroquinone, 2,5-di-t-amylhydroquinone or the like; amines such as phenyl-β-naphthylamine, p-benzylaminophenol, di-β-naphthyl-p-phenylenediamine, dibenzylhydroxylamine, phenylhydroxylamine, diethylhydroxylamine, or the like; nitro compounds such as dinitrobenzenes, trinitrotoluene, picric acid or the like; oximes such as quinone dioxime, cyclohexanone oxime, or the like; phenothiazin, organic and inorganic copper salts, or the like may be exemplified and 2,6-di-t-butyl-4-hydroxytoluene may be preferably exemplified. These compounds may be used alone or used by combination of two or more thereof.

The added amount of the polymerization inhibitor is not particularly limited, as long as the properties of the present invention is not deteriorated. Typically, the amount is 0.01 to 5 parts by weight with respect to 100 parts by weight in total of component (A) and component (B).

(Cured Product)

The photocurable composition of the present invention can be cured by light.

For example, ultraviolet rays, visible light, X-rays, and electron rays can be used as light, and it is preferable to use ultraviolet rays. Since the energy in ultraviolet rays is high, it is possible to accelerate a caring reaction by irradiating the curable composition with ultraviolet rays, and also it is possible to accelerate the curing rate of the curable composition, and it is possible to reduce the amount of the unreacted curable composition in the cured product.

As a method for irradiating with visible light, though it is not particularly limited, for instance, a method using an incandescent bulb, a fluorescent lamp or the like may be exemplified. As a method of irradiating with ultraviolet rays, though it is not particularly limited, a method using a metal halide lamp, a xenon lamp, a low pressure mercury lamp, a high pressure mercury lamp, an ultrahigh pressure mercury lamp, or the like as an electrode method, or an excimer lamp, a metal halide lamp, or the like as an electrodeless method may be exemplified. When using ultraviolet rays, their wavelength range is not particularly limited, but is preferably 150 nm to 400 nm, and more preferably 200 nm to 380 nm. The Irradiation of ultraviolet rays is carried out preferably under an inert gas such as nitrogen gas and carbon dioxide, or an atmosphere in which an oxygen concentration is reduced, but also may be carried out under a normal air. Typically, the temperature in the irradiated area may be 10 to 200° C.

Since a cured state can be measured with a Fourier transformed infrared spectrophotometer, a photochemical reaction calorimeter, and the like, curing conditions (such as light irradiation time, light intensity, heating temperature, and heating time) for curing completely can be selected as appropriate.

### EXAMPLES

While the present invention will be explained in greater detail by referring to the Examples, it should be noted the present invention is not limited to the following Examples. In the following description, “part” represents parts by weight.

Abbreviations used in Examples and Comparative Examples refer to the followings:
IH-1000: a terminal-modified hydrogenated polybutadiene obtained in Production Example 1,
TEAI-1000: a terminal-modified hydrogenated polybutadiene manufactured by Nippon Soda Co., Ltd.,
HDDA: 1,6-hexanediol diacrylate (manufactured by Tokyo Chemical Industry Co., Ltd.),
TCDDA: tricyclodecanedimethanol diacrylate (manufactured by Sigma-Aldrich),
IRGACURE 127: 2-hydroxy-1-(4-(4-(2-hydroxy-2-methyl-propionyl)-benzyl-phenyl)-2-methyl-propan-1-one (manufactured by Ciba Japan K.K.),
IRGACURE 184: 1-hydroxy-cyclohexyl-phenyl ketone (manufactured by Ciba Japan K.K.),
IRGACURE 651: 2,2-dimethoxy-1,2-diphenylethan-1-one (manufactured by Ciba Japan K.K.),
LUCIRIN TPO; 2,4,6-trimethylbenzoyl-diphenyl-phosphine oxide (manufactured by BASF),
DAROCUR 1173: 2-hydroxy-2-methyl-1-phenyl-propan-1-one (manufactured by BASF),
DAROCUR MBF: phenylglyoxylic acid methyl ester (manufactured by BASF),
SB-PI 759: 1-(4-(2-hydroxyethoxy)-phenyl)-2-hydroxy-2-methylpropane (manufactured by Shuang-Bang Ind. crop.), and
BHT: 2,6-di-t-butyl-4-hydroxytoluene (manufactured by Kyodo Chemical Co., Ltd.).

### Production Example 1

In an air atmosphere, 784 parts of isophorone diisocyanate, 6.95 parts of Aluminum Chelate M, and 390 parts of hydroxyethyl acrylate were mixed, which was reacted at 65° C. for one hour to synthesize a reactant A. Subsequently, in an air atmosphere, 1013 parts of the synthesized reactant A, 3000 parts of a hydroxyl group-terminated hydrogenated polybutadiene (GI-1000, manufactured by Nippon Soda Co., Ltd.), and 24.1 parts of Aluminum Chelate M were mixed, which was reacted at 65° C. for two hours. After it was confirmed that the residual NCO was not more than 0.1%, the reaction was quenched to produce a terminal-modified hydrogenated polybutadiene (hereinafter sometimes referred to as IH-1000).

¹H-NMR measurement was conducted on the resulting IH-1000 and two NH signals were confirmed (4.55 and 4.70 ppm). In addition, IR measurement was conducted to confirm the absorption of a urethane bond at 1728 (CO) and 3339 cm⁻¹ (NH). GPC measurement was conducted on the obtained IH-1000 to give a number average molecular weight (Mn) of 3200. The viscosity (P, 45° C.) was 3165, measured using a B-type viscometer.

In the following description, the “residual NCO (%)” represents a percentage by weight of the isocyanate moiety (a multiplier of the mole number and 42.02 (NCO molecular weight)) in a compound.

### Example 1-1

(Preparation of Photocurable Composition A)

4.00 parts of the terminal-modified hydrogenated polybutadiene (IH-1000) obtained in Production Example 1, 16.0 parts of isobornyl acrylate (manufactured by DAICEL-ALLNEX Ltd., trade name IBOA), 1.00 part of 2-hydroxy-2-methyl-1-phenyl-propan-1-one (manufactured by Ciba Japan K.K., trade name DAROCUR (registered trademark) 1173), and 0.1 parts or 2,6-di-t-butyl-4-hydroxytoluene were mixed (a rotation and revolution mixer: Awatori Rentaro (registered trademark), rotation 2000 rpm, 10 min, revolution 2200 rpm, 10 min) to obtain a photocurable composition A.

### Example 1-2

(Production of Cured Product A)

4.00 g of the photocurable composition A obtained in Example 1-1 was poured into an aluminum pan with a diameter of 6.5 cm, which was photo-irradiated with an ultrahigh pressure mercury lamp (10 mW; parallel light type) for eight minutes to obtain a cured product A with a thickness of about 1.0 mm.

### Comparative Example 1-1

(Preparation of Photocurable Composition B)

10.0 parts of the terminal-modified hydrogenated polybutadiene A obtained in Production Example 1, 10.0 parts of isobornyl acrylate (manufactured by DAICEL-ALLNEX Ltd., trade name IBOA), 1.0 part of 2-hydroxy-2-methyl-1-phenyl-propan-1-one (manufactured by Ciba Japan K.K., trade name Darocur (registered trademark) 1173), and 0.1 parts of 2,6-di-t-butyl-4-hydroxytoluene were mixed (a rotation and revolution mixer: Awatori Rentaro (registered trademark), rotation 2000 rpm, 10 min, revolution 2200 rpm, 10 min) to obtain a photocurable composition B.

### Comparative Example 1-2

(Production of Cured Product B)

4.00 g of the photocurable composition B obtained in Comparative Example 1-1 was poured into an aluminum pan with a diameter of 6.5 cm, which was photo-irradiated with an ultrahigh pressure mercury lamp (10 mW; parallel light type) for eight minutes to obtain a cured product B with a thickness of about 1.0 mm.

### Comparative Example 2-1

(Preparation of Photocurable Composition C)

Comparative Example 1-1 was repeated to obtain a photocurable composition C, except that TEAI-1000 (a terminal-modified hydrogenated polybutadiene: manufactured by Nippon Soda Co., Ltd.) was used in place of the terminal-modified hydrogenated polybutadiene A obtained in Production Example 1.

### Comparative Example: 2-2

(Production of Cured Product C)

4.00 g of the photocurable composition C obtained in Comparative Example 2-1 was poured into an aluminum pan with a diameter of 6.5 cm, which was photo-irradiated with an ultrahigh pressure mercury lamp (10 mW; parallel light type) for eight minutes to obtain a cured product C with a thickness of about 1.0 mm.

### Comparative Example 3-1

(Preparation of Photocurable Composition D)

16.0 parts of the terminal-modified hydrogenated polybutadiene A obtained in Production Example 1, 4.0 parts of isobornyl acrylate (manufactured by DAICEL-ALLNEX Ltd., trade name IBOA), 1.0 part of 2-hydroxy-2-methyl-1-phenyl-propan-1-one (manufactured by Ciba Japan K.K., trade name Darocur (registered trademark) 1173), and 0.1 parts of 2,6-di-t-butyl-4-hydroxytoluene were mixed (a rotation and revolution mixer: Awatori Rentaro registered trademark), rotation 2000 rpm, 10 min, revolution 2200 rpm, 10 min) to obtain a photocurable composition D.

### Comparative Example 3-2

(Production of Cured Product D)

4.00 g of the photocurable composition D obtained in Comparative Example 3-1 was poured into an aluminum pan with a diameter of 6.5 cm, which was photo-irradiated with an ultrahigh pressure mercury lamp (10 mW; parallel light type) for ten minutes to obtain a cured product D with a thickness of about 1.0 mm.

### Comparative Example 4-1

(Preparation of Photocurable Composition E)

Comparative Example 3-1repeated to obtain a photocurable composition E, except that TEAI-1000 (a terminal-modified hydrogenated polybutadiene: manufactured by Nippon Soda Co., Ltd.) was used in place of the terminal-modified hydrogenated polybutadiene A obtained in Production Example 1.

### Comparative Example 4-2

(Production of Cured Product E)

4.00 g of the photocurable composition E obtained in Comparative Example 4-1 was poured into an aluminum pan with a diameter of 6.5 cm, which was photo-irradiated with an ultrahigh pressure mercury lamp (10 mW; parallel light type) for ten minutes to obtain a cured product E with a thickness of about 1.0 mm.

(Hue Evaluation Test)

Hue evaluation tests of the cured products A, B, C, D, and E were conducted under the following conditions,

### (1) Hue Evaluation Tests of the Cured Products

Specimens with a width of 25 mm, a length of 50 mm, and a thickness of about 1 mm were made for the cured products A, B, C, D, and E immediately after production, and the L* value, the a* value, and the b* value were determined for each of the specimens by the reflection method using a spectral color-difference meter (“SE-2000”: manufactured by NIPPON DENSHOKU INDUSTRIES Co., LTD). The obtained results are shown in Table 3.

L* values, a* values, and b* values are a type of methods (color systems) for representing colors and numerically represent brightness (L* lightness) and color tone (a*=red−green, b*=yellow−blue) of specific colors using three axes/index.

### (2) Hue Evaluation Tests of Cured Products After Ultraviolet Irradiation

Irradiation was conducted on each of the cured products A, B, C, D, and E with a width of 25 mm, a length of 50 mm, and a thickness of about 1 mm, using a Suga UV fade meter U48 manufactured by Suga Test Instruments Co., Ltd.), at a chamber temperature of about 30° C., at a humidity of 50%, under the irradiation conditions of 500 w/m², 300 to 700 nm, for 16 hours. A hue evaluation test was conducted on each of the cured products A, B, C, D, and E after 16-hour irradiation under the same conditions as in (1). The obtained results are shown in Table 3.

(Determination of Hardness)

A laminate of six specimens with a thickness of 1 mm was made for each of the cured products A, B, C, D, and E immediately after production, and hardness was determined using a durometer according to JIS K 7215. The obtained results are shown in Table 3.

TABLE 3

| | | Hue | | | | | | | |
|---|---|---|---|---|---|---|---|---|---|
| | | Immediately | | | After | | | | |
| | | after | | | ultraviolet | | | Hardness | |
| | Cured | production | | | irradiation | | | Durometer | |
| | product | L* | a* | b* | L* | a* | b* | (A) | (D) |
| Example | A | 91.3 | −0.6 | 1.2 | 83.4 | −1.5 | 4.6 | — | 60 |
| Compar- | B | 90.5 | −0.7 | 1.6 | 86.6 | −1.5 | 4.2 | 98 | 37 |
| ative | C | 89.8 | −0.6 | 1.7 | 85.9 | −2.0 | 8.1 | 98 | 33 |
| example | D | 91.1 | −0.5 | 1.3 | 89.8 | −2.4 | 6.9 | 68 | — |
| | E | 90.6 | −0.3 | 1.0 | 87.4 | −3.7 | 21.5 | 66 | — |

In the table above, “-” refers to “not measured”.

### Example 2

(Preparation of Photocurable Compositions A′ to P′)

IH-1000, a (meth)acrylic acid ester monomer, 1-hydroxycyclohexyl phenyl ketone (manufactured by Ciba Japan K.K., trade name IRGACURE (registered trademark) 184), and BHT were mixed (a rotation and revolution mixer: Awatori Rentaro (registered trademark), rotation 2000 rpm, 10 min, revolution 2200 rpm, 10 min) to obtain photocurable compositions A′ to P′.

TABLE 4

| | | Composition (part) | | | | | | | | | | | | | | | |
|---|---|---|---|---|---|---|---|---|---|---|---|---|---|---|---|---|---|
| | | Example | | | | | | | | Comparative example | | | | | | | |
| | | A′ | B′ | C′ | D′ | E′ | F′ | G′ | H′ | I′ | J′ | K′ | L′ | M′ | N′ | O′ | P′ |
| Component (A) | IH-1000 | 16 | 16 | 10 | 10 | 16 | 16 | 16 | 16 | 16 | 16 | — | — | — | — | — | — |
| | TEAI-1000 | — | — | — | — | — | — | — | — | — | — | 16 | 16 | 16 | 16 | 10 | 10 |
| Component (B) | HDDA | — | — | — | — | — | — | — | — | 4 | 4 | 4 | 4 | — | — | — | — |
| | TCDDA | 4 | 4 | 10 | 10 | 4 | 4 | 4 | 4 | — | — | — | — | 4 | 4 | 10 | 10 |
| Component (C) | IRGACUR E184 | 1 | 1 | 1 | 1 | — | — | — | — | 1 | 1 | 1 | 1 | 1 | 1 | 1 | 1 |
| | IRGACUR E127 | — | — | — | — | 0.5 | 1 | 1 | 2 | — | — | — | — | — | — | — | — |
| Other component | BHT | — | 0.1 | — | 0.1 | — | — | 0.1 | 0.1 | — | 0.1 | — | 0.1 | — | 0.1 | — | 0.1 |

(Production of Cured Products A′ to G′ and I′ to P′)

4.00 of the photocurable compositions A to G and I to P were poured into aluminum pans with a diameter of 6.5 cm, which were photo-irradiated with an ultrahigh pressure mercury lamp (10 mW; parallel light type) for five minutes to obtain cured products A to G′ and I′ to P with a thickness of about 1.0 mm.

(Hue Evaluation Test)

Hue evaluation tests of the cured products A′ to G′ and I′ to P′ were conducted under the following conditions.

Specimens with a width of 25 mm, a length of 50 mm, and a thickness of about 1 mm were made for the cured products A′ to G′ and I′ to P′ immediately after production, and the L* value, the a* value, and the b* value were determined for each of the specimens by the reflection method using a spectral color-difference meter (“SE-2000”: manufactured by NIPPON DENSHOKU INDUSTRIES Co., LTD). The results obtained are shown in Table 4.

L* values:, a* values, and b* values are a type of methods (color systems) for representing colors and numerically represent brightness (L* lightness) and color tone (a*=red−green, b*=yellow−blue) of specific colors using three axes/index.

(Determination of Hardness)

A laminate of six specimens with a thickness of 1 mm was made for each of the cured products A′ to D′ and I′ to P′ and hardness was determined using a durometer according to JIS K 7215. The obtained results are shown in Table 4.

(Tensile Test)

A specimen with a width of 5 mm, a length of 50 mm, and a thickness of about 1 mm was made for each of the cured products A′, B′, E′ to G′, and I′ to N′, and tensile a test was conducted on each of the specimens under the following conditions using AUTOGRAPH AGG-J of Shimadzu Corporation to determine the stress (MPa) and the elastic modulus. The obtained results are shown in Table 4.
Temperature: 24° C.
Humidity: 60%
Distance between grippers: 20 mm
Tensile speed: 20 mm/min
Tensile load, load cell: 5 kN

An elastic modulus is a tensile elastic modulus in a range of the testing force (1 to 2 N) and was calculated by the following calculation formula.

Tensile elastic modulus=[Δtesting force (N)/specimen cross-sectional area (mm²)]/[Δstrain (mm)/distance between grippers (mm)]
Stress (MPa)=maximum stress (MPa)

TABLE 5

| | | | | | Hardness | | Tensile test | |
|---|---|---|---|---|---|---|---|---|
| | Cured | Hue | | | Durometer | Durometer | Stress | Elastic |
| | product | L* | a* | b* | (A) | (D) | (MPa) | modulus |
| Example | A′ | 86.1 | −0.3 | 0.9 | 95 | — | 4.1 | 53.2 |
| | B′ | 85.7 | −0.4 | 0.9 | 94 | — | 4.4 | 55.1 |
| | C′ | 88.8 | −0.6 | 3.6 | — | 73 | — | — |
| | D′ | 85.3 | −0.5 | 2.5 | — | 72 | — | — |
| | E′ | 92.3 | −0.5 | 1.5 | — | — | 5.4 | 57.2 |
| | F′ | 92.1 | −0.4 | 1.5 | — | — | 5.2 | 49.4 |
| | G′ | 91.3 | −0.4 | 1.5 | — | — | 4.7 | 47.4 |
| Comparative | I′ | 92.5 | −0.3 | 0.7 | 91 | — | 2.1 | 30.2 |
| example | J′ | 92.0 | −0.4 | 0.9 | 88 | — | 1.7 | 32.1 |
| | K′ | 90.8 | −0.3 | 1.4 | 91 | — | 2.7 | 25.3 |
| | L′ | 91.3 | −0.4 | 1.2 | 92 | — | 1.9 | 29.4 |
| | M′ | 86.3 | −0.3 | 0.8 | 95 | — | 4.0 | 37.9 |
| | N′ | 89.8 | −0.3 | 0.9 | 94 | — | 3.7 | 46.7 |
| | O′ | 86.7 | −0.4 | 1.5 | — | 74 | — | — |
| | P′ | 86.0 | −0.4 | 1.4 | — | 73 | — | — |

In the table above, “-” refers to “not measured”.

(Hue Evaluation Tests of Cured Products After Ultraviolet Irradiation)

Irradiation was conducted on each of the cured products A′ to D′ and I′ to P′ with a width of 25 mm, a length of 50 mm, and a thickness of about 1 mm, using a Suga UV fade meter U48 (manufactured by Suga Test Instruments Co., Ltd.), at a chamber temperature of about 30° C., at a humidity of 50%, under the irradiation conditions of 500 w/m², 300 to 700 nm. An evaluation teat was conducted on each of the cured products A to D and J to P after 48- and 96-hour irradiations under the same conditions as in the hue evaluation teats described above. The obtained results are shown in Table 6.

TABLE 6

| | Cured | Hue (After 48 hours) | | | Hue (After 96 hours) | | |
|---|---|---|---|---|---|---|---|
| | product | L* | a* | b* | L* | a* | b* |
| Example | A′ | 92.1 | −0.9 | 2.5 | 91.7 | −1.1 | 2.6 |
| | B′ | 92.4 | −1.6 | 4.2 | 92.2 | −1.6 | 4.3 |
| | C′ | 90.1 | −1.3 | 5.9 | 89.5 | −1.5 | 6.0 |
| | D′ | 92.1 | −1.5 | 4.7 | 91.9 | −1.5 | 4.7 |
| Comparative | J′ | 90.3 | −2.3 | 6.6 | 90.0 | −1.9 | 5.4 |
| example | K′ | 85.8 | −1.5 | 16.9 | 84.9 | −1.4 | 20.6 |
| | L′ | 86.4 | −2.9 | 22.4 | 85.8 | −2.3 | 25.1 |
| | M′ | 89.3 | −1.7 | 13.9 | 87.7 | −1.8 | 18.9 |
| | N′ | 89.2 | −2.1 | 14.6 | 87.0 | −1.9 | 18.9 |
| | O′ | 87.4 | −1.4 | 6.7 | 83.1 | −1.7 | 8.5 |
| | P′ | 91.0 | −1.5 | 6.8 | 90.5 | −1.7 | 8.8 |

### Example 3

(Preparation of Photocurable Compositions A″ to H″)

With the compositions shown in Table 3, a terminal-modified hydrogenated polybutadiene, a (meth)acrylic acid ester monomer, 2-hydroxy-1-(4-(4-(2-hydroxy-2-methyl-propionyl)-benzyl)-phenyl)-2-methyl-propan-1-one (manufactured by Ciba Japan K.K., trade name IRGACURE (registered trademark) 127), and BHT were mixed (a rotation and revolution mixer: Awatori Rentaro (registered trademark), rotation 2000 rpm, 10 min, revolution 2200 rpm, 10 min) to obtain photocurable compositions A″ to H″.

TABLE 7

| | | Example | | | | | | | |
|---|---|---|---|---|---|---|---|---|---|
| | | Composition (part) | | | | | | | |
| | | A″ | B″ | C″ | D″ | E″ | F″ | G″ | H″ |
| Component (A) | IH-1000 | 16 | 16 | 16 | 16 | 16 | 16 | 16 | 16 |
| Component (B) | HDDA | 4 | 4 | 4 | 4 | — | — | — | — |
| | TCDDA | — | — | — | — | 4 | 4 | 4 | 4 |
| Component (C) | IRGACURE 127 | 0.5 | 1 | 1 | 2 | 0.5 | 1 | 1 | 2 |
| Other | BHT | — | — | 0.1 | 0.1 | — | — | 0.1 | 0.1 |
| component | | | | | | | | | |

(Preparation of Photocurable Compositions I″ to U″)

With the compositions shown in Table 4, a terminal-modified hydrogenated polybutadiene, a (meth)acrylic acid ester monomer, a photo-radical polymerization initiator, and dibutylhydroxytoluene (hereinafter sometimes referred to as BHT) were mixed (a rotation and revolution mixer: Awatori Rentaro (registered trademark), rotation 2000 rpm, 10 min, revolution 2200 rpm, 10 min) to obtain photocurable compositions I″ to U″.

TABLE 8

| | | Comparative example | | | | | | | | | | | | |
|---|---|---|---|---|---|---|---|---|---|---|---|---|---|---|
| | | Composition (part) | | | | | | | | | | | | |
| | | I″ | J″ | K″ | L″ | M″ | N″ | O″ | P″ | Q″ | R″ | S″ | T″ | U″ |
| Component (A) | IH-1000 | — | 16 | — | — | 16 | — | 16 | — | 16 | — | 16 | — | 16 |
| | TEAI-1000 | 16 | — | 16 | 16 | — | 16 | — | 16 | — | 16 | — | 16 | — |
| Component (B) | HDDA | 4 | 4 | 4 | 4 | 4 | 4 | 4 | 4 | 4 | 4 | 4 | 4 | 4 |
| Component | IRGACURE651 | 1 | 1 | — | — | — | — | — | — | — | — | — | — | — |
| (C) | IRGACURE127 | — | — | 1 | — | — | — | — | — | — | — | — | — | — |
| | IRGACURE184 | — | — | — | 1 | 1 | — | — | — | — | — | — | — | — |
| | LUCIRIN TPO | — | — | — | — | — | 1 | 1 | — | — | — | — | — | — |
| | DAROCUR1173 | — | — | — | — | — | — | — | 1 | 1 | — | — | — | — |
| | DAEOCUR MBF | — | — | — | — | — | — | — | — | — | 1 | 1 | — | — |
| | SB-PI 759 | — | — | — | — | — | — | — | — | — | — | — | 1 | 1 |
| Other | BHT | 0.1 | 0.1 | 0.1 | 0.1 | 0.1 | 0.1 | 0.1 | 0.1 | 0.1 | 0.1 | 0.1 | 0.1 | 0.1 |
| component | | | | | | | | | | | | | | |

(Production of Cured Products A″ to U″)

The photocurable compositions A″ to U″ were poured into aluminum pans with a diameter of 6.5 cm, which were photo-irradiated with an ultrahigh pressure mercury lamp (10 mW; parallel light type) for five minutes to obtain cured products A″ to U″ with a thickness of about 1.0 mm.

(Hue Evaluation Test)

Hue evaluation tests of the resulting cured products A″ to I″, J″, L″ to Q″, and T″ were conducted under the following conditions.

Specimens with a width of 25 mm, a length of 50 mm, and a thickness of about 1 mm were made for the cured products A″ to I″, J″, L″ to Q″, and T″ immediately after production, and the L* value, the a* value, and the b* value were determined for each of the specimens by the reflection method using a spectral color-difference meter (“SE-2000”: manufactured by NIPPON DENSHOKU INDUSTRIES Co., LTD). The obtained results are shown in Table 5.

L* values, a* values, and b* values are a type of methods (color systems) for representing colors and numerically represent brightness (L* lightness) and color tone (a*=red−green, b*=yellow−blue) of specific colors using three axes/index.

(Determination of Hardness)

A laminate of six specimens with a thickness of 1 mm was made for each of the cured products A″ to I″, J″, L″ to Q″, and T″ immediately after production, and hardness was determined using a durometer according to JIS K 7215. The results obtained are shown in Table 9.

(Tensile Test)

A specimen with a width of 5 mm, a length of 50 mm, and a thickness of about 1 mm was made for each of the cured products A″ to I″, J″, L″ to Q″, and T″, and a tensile test was conducted on each of the specimens under the following conditions using AUTOGRAPH AGG-J of Shimadzu Corporation to determine the strain (%). The obtained results are shown in Table 5.

The values of strain (%) were calculated according to the following formula.

Strain (%)=100×(maximum point displacement/distance between grippers)
Temperature: 24° C.
Humidity: 60%
Distance between grippers: 20 mm
Tensile speed: 20 mm/min
Tensile load, load cell: 5 kN

TABLE 9

| | | | | | | Tensile |
|---|---|---|---|---|---|---|
| | Cured | Hue | | | Hardness | test |
| | product | L* | a* | b* | Durometer (A) | Strain (%) |
| Example | A″ | 92.3 | −0.3 | 1.0 | 90 | 11.4 |
| | B″ | 92.6 | −0.4 | 1.3 | 90 | 13.2 |
| | C″ | 92.3 | −0.5 | 1.6 | 90 | 18.6 |
| | D″ | 88.4 | −0.4 | 2.7 | 87 | 14.1 |
| | E″ | 92.3 | −0.5 | 1.5 | — | 19.7 |
| | F″ | 92.1 | −0.4 | 1.5 | — | 24.3 |
| | G″ | 91.3 | −0.4 | 1.5 | — | 26.4 |
| | H″ | 91.0 | −0.5 | 2.1 | — | 33.2 |
| Comparative | I″ | 91.2 | −1.5 | 3.7 | 91 | 9.7 |
| example | J″ | 91.8 | −1.4 | 3.0 | 90 | 8.7 |
| | L″ | 91.3 | −0.4 | 1.2 | 92 | 6.9 |
| | M″ | 92.0 | −0.4 | 0.9 | 88 | 8.4 |
| | N″ | 88.0 | −10.9 | 22.0 | 91 | 11.6 |
| | O″ | 88.4 | −9.8 | 19.6 | 93 | 19.3 |
| | P″ | 91.5 | −0.4 | 1.0 | 95 | 7.7 |
| | Q″ | 91.9 | −0.6 | 1.5 | 92 | 9.6 |
| | T″ | 86.6 | −0.7 | 2.2 | 90 | 9.3 |

In the table above, “-” refers to “not measured”.

(Hue Evaluation Tests of Cured Products After Ultraviolet Irradiation)

Irradiation was conducted on each of the cured products C, I″ to L″, N″, P″, and T″ with a width of 25 mm, a length of 50 mm, and a thickness of about 1 mm, using a Suga UV fade meter U48 (manufactured by Suga Test Instruments Co., Ltd.), at a chamber temperature of about 30° C., at a humidity of 50%, under the irradiation conditions of 500 w/m², 300 to 700 nm. An evaluation test of each of the cured products C″, I″ to L″, N″, P″, and T″ after 48- and 96-hour irradiations was conducted under the same conditions as in the hue evaluation tests described above. The obtained results are shown in Table 10.

TABLE 10

| | Cured | Hue (After 48 hours) | | | Hue (After 96 hours) | | |
|---|---|---|---|---|---|---|---|
| | product | L* | a* | b* | L* | a* | b* |
| Comparative | I″ | 84.1 | −2.5 | 31.1 | 81.7 | −1.0 | 33.6 |
| example | | | | | | | |
| Comparative | J″ | 88.8 | −5.3 | 21.3 | 88.4 | −4.6 | 20.6 |
| example | | | | | | | |
| Comparative | K″ | 85.4 | −2.4 | 24.8 | 82.9 | −1.2 | 28.9 |
| example | | | | | | | |
| Example | C″ | 90.1 | −4.1 | 12.7 | 89.7 | −4.3 | 14.1 |
| Comparative | L″ | 86.4 | −2.9 | 22.4 | 85.8 | −2.3 | 25.1 |
| example | | | | | | | |
| Comparative | N″ | 87.0 | −1.9 | 14.2 | 84.6 | −1.7 | 21.3 |
| example | | | | | | | |
| Comparative | P″ | 85.0 | −2.7 | 22.1 | 83.6 | −2.0 | 24.5 |
| example | | | | | | | |
| Comparative | T″ | 79.5 | −1.1 | 25.1 | 78.5 | 0.3 | 27.6 |
| example | | | | | | | |

(Hue Evaluation Tests of Cured Products After Exposure to Heat)

Each of the cured products C″, I″, K″, N″, P″, R″, and S″ to U″ with a width of 25 mm, a length of 50 mm, and a thickness of about 1 mm was stored at a chamber temperature of about 130° C. for 96 hours. After 96 hours, an evaluation test of each of the cured products was conducted under the same conditions as in the hue evaluation tests described above. The obtained results are shown in Table 11.

TABLE 11

| | | Hue (After 96 hours) | | |
|---|---|---|---|---|
| | Cured product | L* | a* | b* |
| Comparative | I″ | Unmeasurable | | |
| example | | | | |
| Comparative | K″ | Unmeasurable | | |
| example | | | | |
| Example | C″ | 89.2 | −5.5 | 15.5 |

| | | |
|---|---|---|
| Comparative | N″ | Unmeasurable |
| example | | |
| Comparative | P″ | Unmeasurable |
| example | | |
| Comparative | R″ | Unmeasurable |
| example | | |
| Comparative | S″ | Unmeasurable |
| example | | |
| Comparative | T″ | Unmeasurable |
| example | | |
| Comparative | U″ | Unmeasurable |
| example | | |

“Unmeasurable” in the table means that the hue evaluation tests were not able to be conducted due to the contraction of the cured products.

### INDUSTRIAL APPLICABILITY

A colorless and transparent cured product can be obtained by photocuring the photocurable composition of the present invention. The resulting cured product is resistant to yellowing when light-irradiated, and has good mechanical properties, thus the cured product can be a material suitable for optical materials and the like.

1. A photocurable composition comprising:
(A) 5 to 40% by weight of a terminal-modified (hydrogenated) polybutadiene represented by formula [I]: 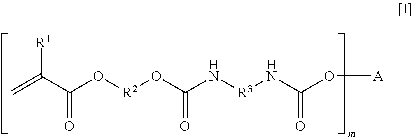
(wherein R¹ represents a hydrogen atom or a methyl group, R² and R³ each independently represent a C1-C10 linear or branched alkylene group, a C3-C8 cycloalkylene group optionally substituted a C1-C6 alkyl group, or a combination of the groups thereof, A represents a polymer chain obtained by polymerizing butadiene, or a polymer chain obtained by hydrogenating the polymer chain thereof, and m represents 1 or 2),
(B) 95 to 60% by weight of a (meth)acrylic acid ester monomer, and
(C) 0.1 to 20 parts by weight of a photo-radical polymerization initiator, with respect to 100 parts by weight in total of said terminal-modified (hydrogenated) polybutadiene and said (meth)acrylic acid ester monomer.

2. The photocurable composition according to claim 1, wherein the terminal-modified (hydrogenated) polybutadiene represented by formula [I] is obtained by reacting an isocyanate represented by formula [II]: 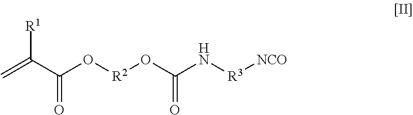
(wherein R¹ represents a hydrogen atom or a methyl group, R² and R³ each independently represent a C1-C10 linear and branched alkylene group, a C3-C8 cycloalkylene group optionally substituted by a C1-C6 alkyl group, or a combination of the groups thereof), with a hydroxyl group-terminated polybutadiene or hydrogenated polybutadiene represented by formula [II]: 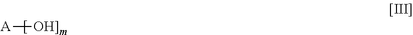
(wherein A represents a polymer chain obtained by polymerizing butadiene, or a polymer chain obtained by hydrogenating the polymer chain thereof, and m represents 1 or 2).

3. A photocurable composition comprising:
(A) a terminal-modified (hydrogenated) polybutadiene represented by formula [I]: 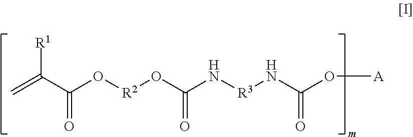
(wherein R¹, R², R³, A, and m have the same meaning as above),
(B) a (meth)acrylic acid ester monomer, and
(C) a photo-radical polymerization initiator represented by formula [IV]: 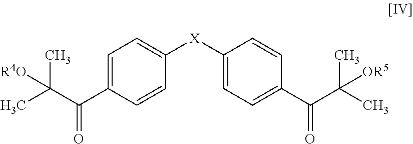
(wherein X represents any one selected from the group consisting of O, CH₂, CH(CH₃), and C(CH₃)₂, and R⁴ and R⁵ each independently represent a hydrogen atom, a methyl group, or a trimethylsilyl group).

4. The photocurable composition according to claim 3, wherein the photo-radical polymerization initiator represented by formula [IV] is 2-hydroxy-1-(4-(4-(2-hydroxy-2-methyl-propionyl)-benzyl)-phenyl)-2-methyl-propan-1-one.

5. The photocurable composition according to claim 3, comprising:
(A) the terminal-modified (hydrogenated) polybutadiene represented by formula [I],
(B) the (meth)acrylic acid ester monomer, and
(C) 3 to 7 parts by weight of the photo-radical polymerization initiator, with respect to 100 parts by weight in total of said terminal-modified (hydrogenated) polybutadiene and (meth)acrylic acid ester monomer.

6. The photocurable composition according to claim 3, wherein the terminal-modified (hydrogenated) polybutadiene represented by formula [I] is obtained by reacting an isocyanate represented by formula [II]: 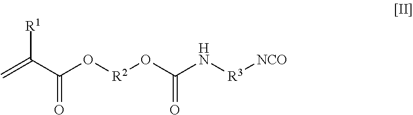
(wherein R¹, R², and R³ have the same meaning as above), with a hydroxyl group-terminated polybutadiene or hydrogenated polybutadiene represented by formula [III]: 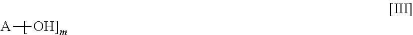
(wherein A and m have the same meaning as above).

7. A photocurable composition comprising:
(A) a terminal-modified (hydrogenated) polybutadiene represented by formula [I]: 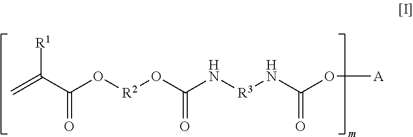
(wherein R¹, R², R³, A, and m have the same meaning as above),
(B) tricyclodecanedimethanol di(meth)acrylate, and
(C) a photo-radical polymerization initiator.

8. The photocurable composition according to claim 7, wherein the terminal-modified (hydrogenated) polybutadiene represented by formula [I] is obtained by reacting an isocyanate represented by formula [II]: 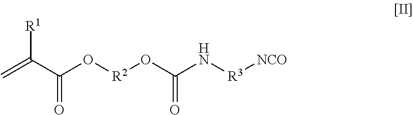
(wherein R¹, R², and R³ have the same meaning as above), with a hydroxyl group-terminated polybutadiene or hydrogenated polybutadiene represented by formula [III]: 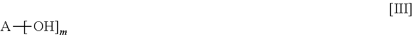
(wherein A and m have the same meaning as above).

9. The photocurable composition according to claim 1, wherein the terminal-modified (hydrogenated) polybutadiene represented by formula [I] has a number average molecular weight (Mn) of 1,000 to 100,000.

10. A cured product obtained by photocuring the photocurable composition as claimed in claim 1.
